(19) United States
(12) Patent Application Publication
(10) Pub. No.: US 2021/0325951 A1
(43) Pub. Date: Oct. 21, 2021

(54) SYSTEM BASIS CHIP

(71) Applicant: Texas Instruments Incorporated, Dallas, TX (US)

(72) Inventors: Vijayalakshmi DEVARAJAN, Plano, TX (US); Wesley Ryan RAY, Frisco, TX (US); Richard Edwin Hubbard, Lavon, TX (US)

(21) Appl. No.: 17/178,789

(22) Filed: Feb. 18, 2021

Related U.S. Application Data
(60) Provisional application No. 63/010,875, filed on Apr. 16, 2020.

(51) Int. Cl. G06F 1/3234; G06F 1/26; G06F 13/42

(52) U.S. Cl. CPC G06F 1/325; G06F 13/4282; G06F 1/266

(57) ABSTRACT

A system basis chip (SBC) includes a serial peripheral interface for communication with a processor, a set of registers for storing information operable to control an external communication interface device, and a control signal output adapted to be coupled to the external communication interface device. In some implementations, the set of registers includes a first register for information indicative of a function of the control signal, and a second register for information indicative of a value of the control signal. The function of the control signal for the external communication interface device can be a supply voltage interrupt, a watchdog interrupt event, a counter-based watchdog interrupt event, a local wakeup request, a bus wakeup request, an entrance into a fail-safe mode of operation, or a general purpose output signal. In some implementations, the SBC also includes a supply voltage output adapted to be coupled to the external communication interface device.

### CROSS-REFERENCE TO RELATED APPLICATIONS

This application claims priority to U.S. Provisional Application No. 63/010,875, filed Apr. 16, 2020, which is hereby incorporated by reference.

### BACKGROUND

Some electronic systems (such as systems within an automobile) are adding more subsystems and need additional communication channels, such as control area networks (CAN) and local interconnect networks (LIN) to integrate these subsystems. System Basis Chips (SBCs) may be utilized to regulate system power and provide communications to/from a microcontroller/processor. For example, as automobiles incorporate more complex electronic subsystems (such as for driver assistance and safety features), some systems incorporate larger SBCs with excess feature sets or discrete transceivers controlled by the processor's input/output pins to implement more communication interface devices.

However, SBCs with excess feature sets can include features unnecessary in a particular implementation, leading to a larger bill of materials cost and a more complex software footprint for features left unused. Similarly, discrete communication interface devices are controlled by the processor's input/output pins, reducing the number of input/output pins available for other uses, and can require additional supporting components such as voltage regulators, increasing the bill of materials cost and area of the integrated circuit.

### SUMMARY

A system basis chip (SBC) includes a serial peripheral interface (SPI) for communication with a processor, a set of registers for storing information operable to control an external communication interface device, and a control signal output adapted to be coupled to the external communication interface device. In some embodiments, the external communication interface device is an external local interconnect network device. In other embodiments, the external communication interface device is an external control area network device.

The set of registers can include a first register for storing information indicative of a function of the control signal for the external communication interface device and a second register for storing information indicative of a value of the control signal for the external communication interface device. The information indicative of the function of the control signal for the external communication interface device can include information indicative of at least one of: a supply voltage interrupt, a watchdog interrupt event, a counter-based watchdog interrupt event, a local wakeup request, a bus wakeup request, an entrance into a fail-safe mode of operation, and a general purpose output signal.

In some implementations, the control signal output is a first control signal output, and the SBC also includes a second control signal output adapted to be coupled to a voltage regulator for selectively enabling a supply voltage and a supply voltage input adapted to be coupled to a power supply. The SBC can further comprise a supply voltage output adapted to be coupled to the external communication interface device. The second control signal for selectively enabling the supply voltage can be configured to selectively enable a first supply voltage for a first type of external communication interface device and a second supply voltage for a second type of external communication interface device. The supply voltage input receives the first supply voltage or the second supply voltage, and the supply voltage output adapted to be coupled to the external communication interface device provides the first supply voltage or the second supply voltage to the external communication interface device.

The SBC can further include a wakeup signal input adapted to be coupled to a wakeup controller. In some implementations, the wakeup signal input is a first wakeup signal input, and the external communication interface device includes a second wakeup signal input adapted to be coupled to the wakeup controller. In some embodiments, the wakeup controller is a first wakeup controller, and the second wakeup signal input of the external communication interface device is adapted to be coupled to a second wakeup controller.

### BRIEF DESCRIPTION OF THE DRAWINGS

For a detailed description of various examples, reference will now be made to the accompanying drawings in which:

FIGS. 1A-B show block diagrams of an example system including a system basis chip (SBC) and different types of external control area network (CAN) interface devices.

FIGS. 2A-C show block diagrams of an example system including an SBC and different types of external local interconnect network (LIN) interface devices.

FIG. 3 shows a table of registers in the SBCs shown in FIGS. 1A-B and 2A-C used to control the external communication interface devices.

The same reference numerals are used in the drawings to designate the same or similar (by function and/or structure) features.

### DETAILED DESCRIPTION

The disclosed system basis chip (SBC) enables a processor to control an external communication interface device via the SBC, rather than directly via the processor's own general purpose input/output pins. The SBC provides a control signal and can also provide a supply voltage to the external communication interface device. The SBC includes a serial peripheral interface (SPI) configured to communicate with the processor and a set of registers configured to store information for controlling the external communication interface device. For example, the set of registers includes a first register for a polarity for the control signal and a second register for what information causes the control signal to be active.

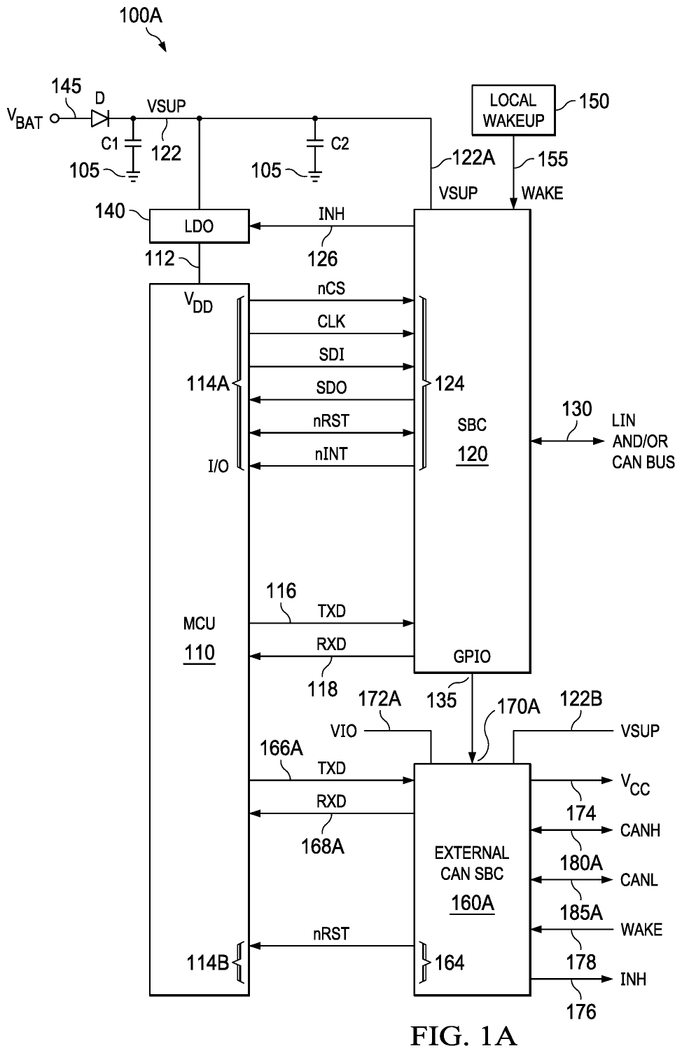

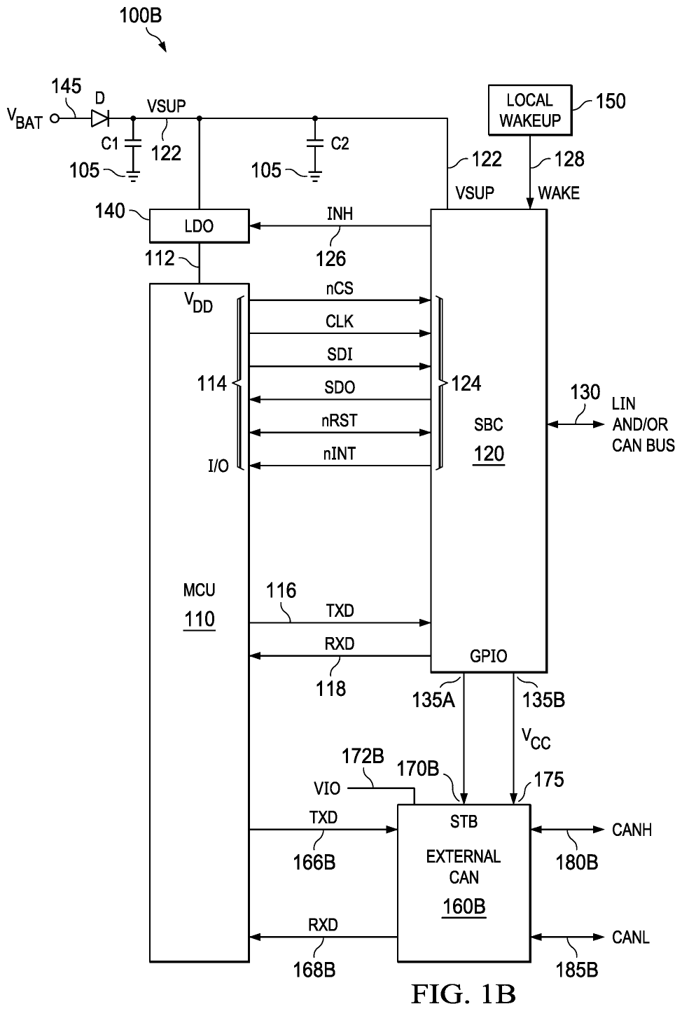

FIGS. 1A-B show block diagrams of an example system 100A and 100B including an SBC 120 and different types of external control area network (CAN) interface devices 160A and 160B. System 100 includes a microcontroller (MCU) 110, a low-dropout regulator (LDO) 140, and a local wakeup controller 150. System 100 includes an MCU, but any appropriate controller or processor can be used. MCU 110 is configured to receive a supply voltage Vdd 112 (e.g., 3.3 volts) from LDO 140 and includes an SPI 114 over which MCU 110 communicates with the SPI 124 included in SBC 120. Within the SPIs 114 and 124, nCS is an interface for selection of an SPI chip. CLK is an input interface for an SPI clock signal. SDI is an input interface for SPI slave data input from a master output. SDO is an output interface for SPI slave data output to the master input. nINT is an interrupt interface to MCU 110. nRST is a reset interface between SBC 120 and MCU 110.

The LDO 140 is coupled to capacitors C1 and C2, which are further coupled to common potential (e.g. ground) 105. System 100 includes an LDO, but any appropriate voltage regulator can be used. The capacitors C1 and C2 and LDO 140 are coupled to an output of diode D, which is configured to receive a battery voltage VBAT 145 (e.g., 14 volts). LDO 140 is connected to supply voltage VSUP 122A, which is also provided to SBC 120. SBC 120 outputs a control signal INH 126 to LDO 140 to selectively enable different regulated voltages from LDO 140. For example, INH 126 can enable a 3.3 volt supply voltage VSUP 122A or a 5 volt supply voltage VSUP 122A.

SBC 120 receives a wakeup signal WAKE 128 from local wakeup controller 150. SBC 120 also includes a local interconnect network (LIN) bus and/or a CAN bus 130. MCU 110 controls the state of the LIN or CAN bus 130 via TXD 116, and SBC 120 reports the state of the LIN or CAN bus 130 to MCU 110 via RXD 118. SBC 120 provides a control signal to the external communication interface device 160A via general purpose input/output (GPIO) pin 135. In some implementations, SBC 120 can provide a supply voltage to the external communication interface device 160, as discussed further herein with reference to FIG. 1B.

System 100A shown in FIG. 1A includes an external CAN SBC 160A, and the SPI 114 of MCU 110 is divided into SPI 114A and 114B. SPI 114A is used to communicate with SBC 120, and SPI 114B is used to communicate with SPI 164 of the external CAN SBC 160A. The external CAN SBC 160A communicates the reset signal nRST to MCU 110 via SPI 164. The external CAN SBC 160A receives a digital input/output voltage supply VIO 172A and the supply voltage VSUP 122B based on VBAT 145. The external CAN SBC 160A outputs a control signal INH 176 to LDO 140 to selectively enable different regulated voltages from LDO 140. For example, INH 176 can enable a 3.3 volt supply voltage VSUP 122B or a 5 volt supply voltage VSUP 122B. The control signal INH 126 selectively enables different regulated supply voltages VSUP 122A for SBC 120, and the control signal INH 176 selectively enables different regulated supply voltages VSUP 122B for the external CAN SBC 160A. The external CAN SBC 160A receives a wakeup signal WAKE 178, for example from local wakeup controller 150, and the control signal from GPIO 135 of SBC 120 at a standby (STB) pin 170A.

The external CAN SBC 160A can output a supply voltage Vcc 174 (e.g., 3.3 volts) to other external devices, and communicate with the other external devices over a high-level CAN bus CANH 180A and a low-level CAN bus CANL 185A. MCU 110 controls the state of the CANH and CANL buses 180A and 185A via TXD 166A, and the external CAN SBC 160A reports the state of the CAN buses 180A and 185A to MCU 110 via RXD 168A. In contrast to conventional systems which require a full SPI interface between MCU 110 and the external CAN SBC 160A as well as between MCU 110 and the SBC 120, the only full SPI interface in system 100A is between MCU 110 and the SBC 120. The SPI interface between SPI 114B of MCU 110 and SPI 164 of external CAN SBC 160A is only a partial interface, encompassing only the reset signal nRST. The nCS, CLK, SDI, SDO, and nINT interfaces are limited to between MCU 110 and SBC 120, and SBC 120 dictates the interface selection, clock signal, SPI inputs and outputs, and interrupts for the external CAN SBC 160A via the control signal output to GPIO pin 135. Thus, GPIO pins on MCU 110 that would otherwise be used to control the external CAN SBC 160A can be freed up for other purposes.

In system 100A, the external CAN SBC 160A has independent power and wakeup systems from SBC 120. Alternatively, as shown in system 100B in FIG. 1B, the SBC 120 can provide a supply voltage and wakeup signals to the external communication interface device. System 100B includes an external CAN transceiver 160B. The SBC 120 outputs a control signal for the external CAN transceiver 160B via GPIO pin 135A and a supply voltage Vcc via output pin 135B. The external CAN transceiver 160B includes a standby (STB) pin 170B configured to receive the control signal from GPIO pin 135A of SBC 120, and a supply voltage Vcc pin 175 configured to receive the supply voltage from output pin 135B of SBC 120.

The external CAN transceiver 160B receives a digital input/output voltage supply VIO 172B based on VBAT 145 for example, and also includes a high level CAN bus CANH 180B and a low-level CAN bus CANL 185B. MCU 110 controls the state of the CANH and CANL buses 180B and 185B via TXD 166B, and the external CAN transceiver 160B reports the state of the CAN buses 180B and 185B to MCU 110 via RXD 168B. Similar to system 100A, the only full SPI interface in system 100B is between MCU 110 and the SBC 120. The nCS, CLK, SDI, SDO, nINT, and nRST interfaces are limited to between MCU 110 and SBC 120, and SBC 120 dictates the interface selection, clock signal, SPI inputs and outputs, interrupts, and resets for the external CAN SBC 160A via the control signal output to GPIO pin 135. Thus, GPIO pins on MCU 110 that would otherwise be used to control the external CAN transceiver 160B can be freed up for other purposes. In system 100B, the SBC 120 provides wakeup signals and the supply voltage to external CAN transceiver 160B over GPIO pin 135A and output pin 135B, respectively, which can reduce the amount of additional circuitry needed to support the external CAN transceiver 160B, such as an additional wakeup controller, voltage regulator, and/or the like.

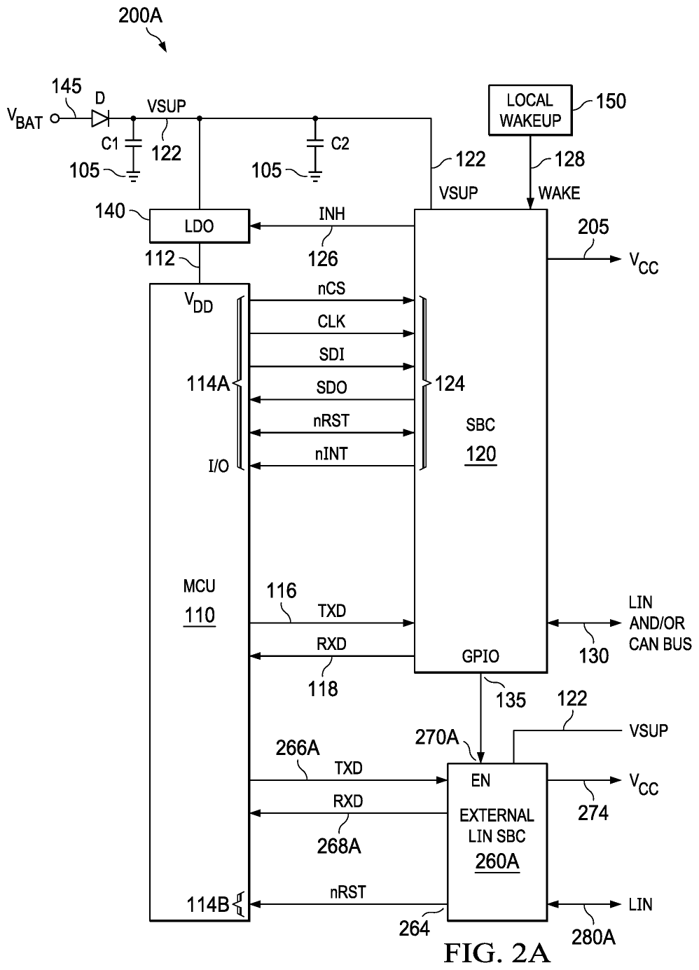

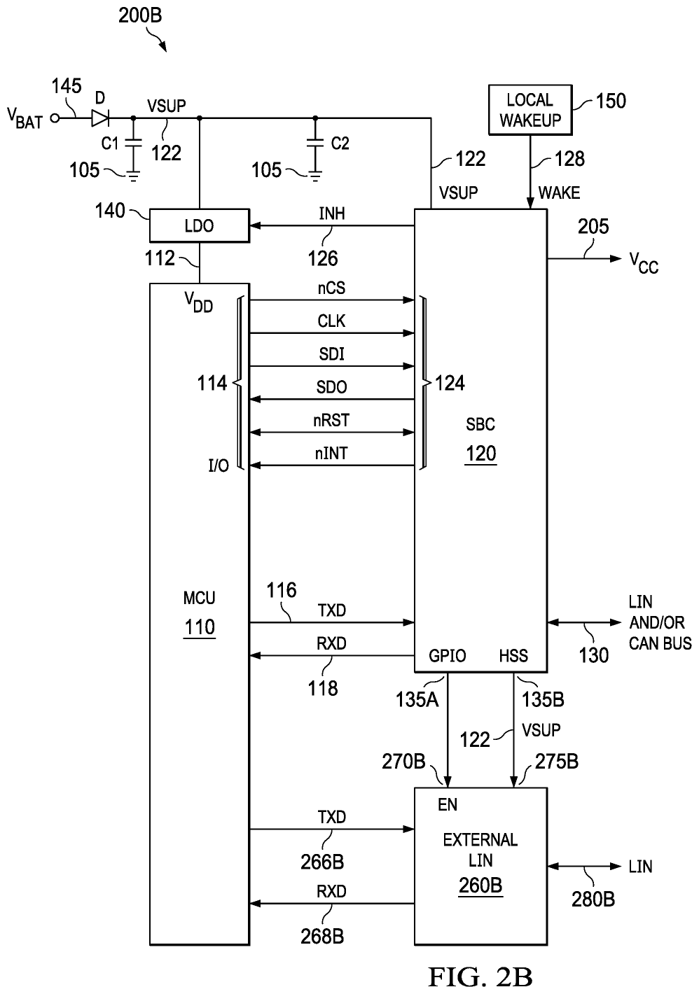

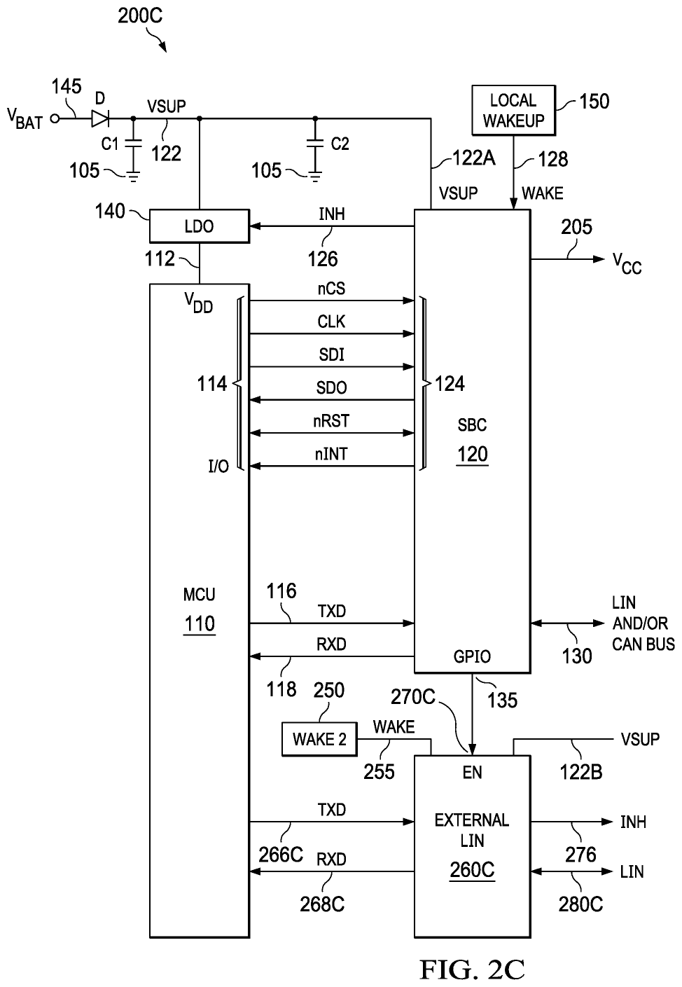

FIGS. 2A-C show block diagrams of an example system (200A, 200B and 200C) including an SBC 120 and different types of external local interconnect network (LIN) interface devices (260A, 260B and 260C). Systems 200A-C are similar to systems 100A-B shown in FIGS. 1A-B, but include external LIN interface devices (260A-C) instead of external CAN interface devices (160A-B). System 200A shown in FIG. 2A includes an external LIN SBC 260A, and the SPI 114 of MCU 110 is divided into SPI 114A and 114B. SPI 114A is used to communicate with SBC 120, and SPI 114B is used to communicate with SPI 264 of the external LIN SBC 260A. The external LIN SBC 260A communicates the reset signal nRST to MCU 110 via SPI 264.

The external LIN SBC 260A receives the supply voltage VSUP 122 based on VBAT 145 and the control signal from GPIO 135 of SBC 120 at an enable (EN) pin 270A. The external LIN SBC 260A can output a supply voltage Vcc 274 (e.g., 5 volts) to other external devices, and communicate with the other external devices over a LIN bus 280A. In some example embodiments, bus 280A is bi-directional. MCU 110 controls the state of the LIN bus 280A via TXD 266A, and the external LIN SBC 260A reports the state of the LIN bus 280A to MCU 110 via RXD 268A. Similar to systems 100A and 100B, the only full SPI interface in system 200A is between MCU 110 and the SBC 120. The SPI interface between SPI 114B of MCU 110 and SPI 264 of external LIN SBC 260A is only a partial interface, encompassing only the reset signal nRST. The nCS, CLK, SDI, SDO, and nINT interfaces are limited to between MCU 110 and the SBC 120, and SBC 120 dictates the interface selection, clock signal, SPI inputs and outputs, and interrupts for the external LIN SBC 260A via the control signal output to GPIO pin 135. Thus, GPIO pins on MCU 110 that would otherwise be used to control the external LIN SBC 260A can be freed up for other purposes.

In system 200A, the external LIN SBC 260A has an independent power system from SBC 120. Alternatively, as shown in system 200B in FIG. 2B, the SBC 120 can provide a supply voltage to the external communication interface device. System 200B includes an external LIN transceiver 260B. The SBC 120 outputs a control signal for the external LIN transceiver 260B to GPIO pin 135A and a supply voltage VSUP 122 to output pin 135B. In this embodiment, output pin 135B is a high-side switch (HSS). The external LIN transceiver 260B includes an EN pin 270B configured to receive the control signal from GPIO pin 135A of SBC 120, and a supply voltage pin 275B configured to receive the supply voltage VSUP 122 from output pin 135B of SBC 120.

The external LIN transceiver 260B includes a LIN bus 280B, which is bi-directional in some example embodiments. MCU 110 controls the state of the LIN bus 280B via TXD 266B, and the external LIN transceiver 260B reports the state of the LIN bus 280B to MCU 110 via RXD 268B. Similar to systems 100A-B and 200A, the only full SPI interface in system 200B is between MCU 110 and the SBC 120. The nCS, CLK, SDI, SDO, nINT, and nRST interfaces are limited to between MCU 110 and SBC 120, and SBC 120 dictates the interface selection, clock signal, SPI inputs and outputs, interrupts, and resets for the external LIN transceiver 260B via the control signal output to GPIO pin 135. Thus, GPIO pins on MCU 110 that would otherwise be used to control the external LIN transceiver 260B can be freed up for other purposes. In system 200B, the SBC 120 provides the supply voltage VSUP 122 to external LIN transceiver 260B via output pin 135B, which can reduce the amount of additional circuitry needed to support the external LIN transceiver 260B, such as an additional wakeup controller, voltage regulator, and/or the like. In system 200B, SBC 120 can shut off external LIN transceiver 260B to further conserve power while control signals from MCU 110 indicate external LIN transceiver 260B should operate in a sleep mode.

In a further alternative, as shown in system 200C in FIG. 2C, the external communication interface device can have independent power and wakeup systems from SBC 120. System 200C includes an external LIN transceiver 260C. The SBC 120 outputs a control signal for the external LIN transceiver 260C to GPIO pin 135. The external LIN transceiver 260C includes an EN pin 270C configured to receive the control signal from GPIO pin 135 of SBC 120. The external LIN transceiver 260C receives the supply voltage VSUP 122B based on VBAT 145, while the SBC 120 receives the supply voltage VSUP 122A.

The external LIN transceiver 260C outputs a control signal INH 276 to LDO 140 to selectively enable different regulated voltages from LDO 140. For example, INH 276 can enable a 3.3 volt supply voltage VSUP 122B or a 5 volt supply voltage VSUP 122B. The control signal INH 126 selectively enables different regulated supply voltages VSUP 122A for the SBC 120, and the control signal INH 276 selectively enables different regulated supply voltages VSUP 122B for the external LIN transceiver 260C. The external CAN SBC 260C receives a wakeup signal WAKE 255 from a second wakeup controller 250. The external LIN transceiver 260C includes a LIN bus 280C. MCU 110 controls the state of the LIN bus 280C via TXD 266C, and the external LIN transceiver 260C reports the state of the LIN bus 280C to MCU 110 via RXD 268C.

Similar to systems 100A-B and 200A-B, the only full SPI interface in system 200C is between MCU 110 and the SBC 120. The nCS, CLK, SDI, SDO, nINT, and nRST interfaces are limited to between MCU 110 and SBC 120, and SBC 120 dictates the interface selection, clock signal, SPI inputs and outputs, interrupts, and resets for the external LIN transceiver 260C via the control signal output to GPIO pin 135. Thus, GPIO pins on MCU 110 that would otherwise be used to control the external LIN transceiver 260C can be freed up for other purposes. In system 200C, the external LIN transceiver 260C has independent power and wakeup systems from SBC 120.

In each of systems 100A-B and 200A-C, SBC 120 controls the external communication interface device, such that GPIO pins on MCU 110 can be used for other purposes. In addition, systems 100A-B and 200A-C have lower bill of materials costs and simpler software footprints than conventional systems using larger SBCs with additional channels and excess feature sets. In systems 100B and 200B, SBC 120 also provides power to the external communication interface device, further reducing the bill of materials cost and the area occupied by systems 100B and 200B relative to conventional systems including additional devices such as LDOs to support the external communication interface devices.

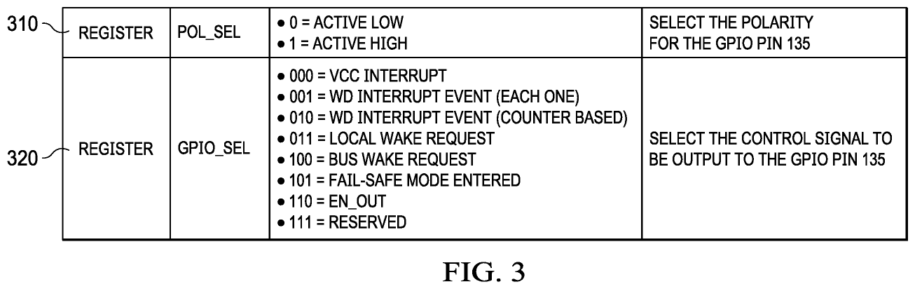

FIG. 3 shows a table of registers in SBC 120 shown in FIGS. 1A-B and 2A-C used to control the external communication interface devices. Register 310 indicates a polarity of the GPIO pin 135 in the SBC 120. For example, a value of zero can indicate the GPIO pin 135 is active low, and a value of one can indicate the GPIO pin 135 is active high.

Register 320 indicates a function of the control signal that SBC 120 outputs to GPIO pin 135. For example, a value of 000 can indicate that the control signal is a supply voltage interrupt. A value of 001 can indicate that the control signal is a watchdog (WD) interrupt event each time one occurs, and a value of 010 can indicate that the control signal is a second watchdog interrupt event based on a counter. A value of 011 can indicate that the control signal is a local wakeup request such as from local wakeup controller 150 in system 100B, and a value of 100 can indicate that the control signal is a bus wakeup request. A value of 101 can indicate a fail-safe mode has been entered. A value of 110 can indicate that the control signal is general purpose output signal, and a value of 111 can be reserved for any appropriate purpose.

In this description, the term “couple” may cover direct and indirect connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

The uses of the phrase “ground voltage potential” in this description include a chassis ground, an Earth ground, a floating ground, a virtual ground, a digital ground, a common ground, and/or any other form of ground connection applicable to, or suitable for, the teachings of this description. Unless otherwise stated, “about”, “approximately”, or “substantially” preceding a value means +/−10 percent of the stated value.

As used herein, the terms “terminal”, “node”, “interconnection” and “pin” are used interchangeably. Unless specifically stated to the contrary, these terms are generally used to mean an interconnection between or a terminus of a device element, a circuit element, an integrated circuit, a device or other electronics or semiconductor component. While some buses and/or interconnections are shown as unidirectional or bidirectional, each of these buses and/or interconnections can be either unidirectional or bidirectional. As used herein, the terms “port”, “connector”, “interface” or similar terminology are used interchangeably and are used broadly to mean any type of connection or interface between a device (whether a packaged semiconductor device), integrated circuit (packaged, unpackaged, formed on one or more semiconductor substrates or formed on a portion of a semiconductor substrate) and a bus or series of conductors that facilitate the exchange of data, power, control signals, clocking signals and/or other communications.

Modifications are possible in the described embodiments, and other embodiments are possible, within the scope of the claims.

What is claimed is:

1. A system basis chip (SBC), comprising:
a serial peripheral interface (SPI) for communication with a processor;
a set of registers for storing information operable to control an external communication interface device; and
a control signal output adapted to be coupled to the external communication interface device.

2. The SBC of claim 1, wherein the set of registers comprises:
a first register for storing information indicative of a function of the control signal for the external communication interface device; and
a second register for storing information indicative of a value of the control signal for the external communication interface device.

3. The SBC of claim 2, wherein the information indicative of the function of the control signal for the external communication interface device comprises information indicative of at least one of: a supply voltage interrupt, a watchdog interrupt event, a counter-based watchdog interrupt event, a local wakeup request, a bus wakeup request, an entrance into a fail-safe mode of operation, and a general purpose output signal.

4. The SBC of claim 1, wherein the control signal output is a first control signal output and the control signal is a first control signal, wherein the SBC further comprises:
a second control signal output for selectively enabling a supply voltage; and
a supply voltage input.

5. The SBC of claim 4, wherein the SBC further comprises a supply voltage output for the external communication interface device.

6. The SBC of claim 5, wherein the second control signal for selectively enabling the supply voltage is configured to selectively enable a first supply voltage for a first type of external communication interface device and a second supply voltage for a second type of external communication interface device, wherein the supply voltage input is configured to receive the first supply voltage or the second supply voltage, and wherein the supply voltage output is configured to provide the first supply voltage or the second supply voltage for the external communication interface device.

7. A system, comprising:
a processor;
an external communication interface device;
a voltage regulator having an input adapted to be coupled to a power source;
a wakeup controller; and
a system basis chip (SBC), comprising:
a serial peripheral interface (SPI) configured to communicate with the processor,
a set of registers for storing control information;
a first control signal output coupled to the external communication interface device,
a second control signal output coupled to the voltage regulator,
a supply voltage input adapted to be coupled to the power source, and
a wakeup signal input coupled to the wakeup controller.

8. The system of claim 7, wherein the wakeup controller is a first wakeup controller and the wakeup signal is a first wakeup signal, the system further comprising a second wakeup controller, wherein the external communication interface device comprises a wakeup signal input coupled to the second wakeup controller.

9. The system of claim 7, wherein the wakeup signal is a first wakeup signal, and wherein the external communication interface device comprises a wakeup signal input coupled to the wakeup controller.

10. The system of claim 7, wherein the external communication interface device comprises a supply voltage input adapted to be coupled to the power source.

11. The system of claim 10, wherein the external communication interface device further comprises a third control signal output for the voltage regulator.

12. The system of claim 7, wherein the SBC further comprises a supply voltage output for the external communication interface device.

13. The system of claim 7, wherein the set of registers comprises:
a first register for storing information indicative of a function of the first control signal for the external communication interface device; and
a second register for storing information indicative of a value of the first control signal for the external communication interface device.

14. The system of claim 13, wherein the information indicative of the function of the first control signal for the external communication interface device comprises information indicative of at least one of: a supply voltage interrupt, a watchdog interrupt event, a counter-based watchdog interrupt event, a local wakeup request, a bus wakeup request, an entrance into a fail-safe mode of operation, and a general purpose output signal.

15. The system of claim 7, wherein the external communication interface device comprises an external local interconnect network device.

16. The system of claim 7, wherein the external communication interface device comprises an external control area network device.

17. A system basis chip (SBC) adapted to be coupled to an external communication interface device that is operable to communicate over an external bus, the SBC comprising:
a serial peripheral interface (SPI) port adapted to be coupled to a processor;
an external communications port adapted to be coupled to the external communication interface device;
registers operable to store external communications control signals; and
wherein the SBC is operable to provide the external communications control signals to the external communication interface device by the external communications port.

18. The SBC of claim 17, further comprising:
a voltage regulator port adapted to be coupled to a voltage regulator;
a wakeup controller port adapted to be coupled to a wakeup controller; and
a supply voltage port adapted to be coupled to a power source.

19. The SBC of claim 17, wherein the registers comprise:
a first register for storing information indicative of a function of the external communications control signals; and
a second register for storing information indicative of a value of the external communications control signals.

20. The SBC of claim 19, wherein the information indicative of the function of the external communications control signals comprises information indicative of at least one of: a supply voltage interrupt, a watchdog interrupt event, a counter-based watchdog interrupt event, a local wakeup request, a bus wakeup request, an entrance into a fail-safe mode of operation, and a general purpose output signal.
